(19) United States
(12) Patent Application Publication
(10) Pub. No.: US 2026/0358876 A1
(43) Pub. Date: Nov. 12, 2026

(54) DISPLAY DEVICES WITH POWER CONTROL BASED ON TEMPERATURE DATA

(71) Applicant: ROKU, INC., San Jose, CA (US)

(72) Inventors: Sheng Hong WANG, Hsinchu City (TW); Steve Shaw-Jong LIU, Mountain View, CA (US); Taiquan LU, San Jose, CA (US); Xiu Long WEI, Hsinchu City (TW)

(73) Assignee: ROKU, INC., San Jose, CA (US)

(21) Appl. No.: 19/201,480

(22) Filed: May 7, 2025

(51) Int. Cl. G06F 1/3234; G06F 1/3218; G06F 1/3296

(52) U.S. Cl. CPC G06F 1/3265; G06F 1/3218; G06F 1/3296

(57) ABSTRACT

Disclosed herein are system, apparatus, article of manufacture, method and/or computer program product embodiments, and/or combinations and sub-combinations thereof, for controlling power to a display based on temperature data. An example embodiment of a display device includes a display panel, a display driver, a first board comprising a power supply unit (PSU) and a sensor, and a second board comprising a controller. The PSU can provide power to the display panel, while the sensor can collect temperature data indicating a temperature of a hotspot of the first board or the PSU. A signal based on the temperature data can be sent to the controller of the second board. The controller can receive the signal based on the temperature data, and send a command to the display driver to reduce power consumption by the display panel in response to the signal indicating the temperature of the hotspot exceeds a predetermined threshold.

### BACKGROUND

### Field

This disclosure is generally directed to display devices, and more particularly to display devices with power control based on temperature data.

### SUMMARY

Provided herein are system, apparatus, article of manufacture, method and/or computer program product embodiments, and/or combinations and sub-combinations thereof, for controlling power to a display device based on temperature data. In some aspects, a display device is disclosed, the display device including a display panel configured to display information, a display driver coupled to the display panel, a first board comprising a power supply unit (PSU) and a sensor, and a second board comprising a controller. The PSU can be configured to provide power to the display panel, while the sensor can be configured to collect temperature data indicating a temperature of a hotspot of the first board or the PSU. A signal based on the temperature data collected by the sensor can be sent to the controller of the second board. In addition, the controller can be configured to receive the signal based on the temperature data, and further send a command to the display driver to reduce power consumption by the display panel in response to the signal indicating the temperature of the hotspot exceeds a predetermined threshold.

In some aspects, a method for a controller of a display device are disclosed. The method can include the controller receiving a signal based on temperature data collected by a sensor located on a first board indicating a temperature of a hotspot, where the first board can include a power supply unit (PSU) configured to provide power to a display panel of the display device. In some embodiments, the controller can be located in a second board separated from the first board. The method can further include determining a command to a display driver to reduce power consumption by the display panel in response to the signal indicating that the temperature of the hotspot exceeds a predetermined threshold. The method can further include transmitting the command to the display driver to reduce the power consumption of the display panel.

In some aspects, a display device can include a display panel, a light-emitting diode (LED) backlight, a display driver, a first board, and a second board. The display device can be configured to display information. The LED backlight can be configured to control a brightness of the display panel. The display driver can be configured to control operations of the LED backlight. The first board can include a power supply unit (PSU) and a sensor, where the PSU can be configured to provide power to the display panel, and the sensor can be configured to collect temperature data indicating a temperature of a hotspot of the PSU or the first board. The second board can include a controller. The first board can be configured to send to the controller of the second board a signal based on the temperature data collected by the sensor. The controller can be configured to receive the signal based on the temperature data, and further send a command to the display driver to adjust the brightness level of the LED backlight in response to the signal indicating that the temperature of the hotspot exceeds a predetermined threshold.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a streaming media device, according to some embodiments.

FIG. 3 illustrates a block diagram of a display device, according to some embodiments.

FIG. 4 illustrates a flow diagram of a method for a controller to control power consumption of a display panel of a display device, according to some embodiments.

FIG. 5 illustrates a flow diagram of a method for a controller to control power consumption of a display panel of a display device, according to some embodiments.

FIG. 6 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for controlling power to a display device based on temperature data. In some embodiments, a display device can include a display panel, a display driver coupled to the display panel, a power supply unit (PSU), a sensor, and a controller to control the power consumption of the display panel. In some embodiments, the sensor can be located within the PSU to measure a temperature of a hotspot within the PSU, while the controller can control the power consumption of the display panel based on the measured temperature. In some embodiments, the PSU and the sensor can be located at a first board, while the controller can be located in a second board separated from the first board.

A display device plays an important role in delivering information to users. A display device can be an output device for presentation of some input information. When the input information supplied to a display device includes an electrical signal, the display device can be called an electronic display. Common applications for electronic visual displays include television sets, computer monitors, or other applications. A display device can be manufactured using various technologies, such as cathode-ray tube display (CRT), liquid-crystal display (LCD), light-emitting diode (LED) backlit LCD, thin-film transistor (TFT) LCD, quantum dot (QLED) display, digital light processing display (DLP), light-emitting diode (LED) display, organic LED (OLED) display, active-matrix organic light-emitting diode (AMOLED) display, super AMOLED display, vacuum fluorescent display, electroluminescent (ELD) display, plasma (PDP) display, laser-powered phosphor display, and other kinds of display devices.

In some embodiments, a display device or its components can be designed based on maximum loading and worst intended use cases, where a use case refers to a scenario or situation the display device is used, such as a specific temperature of the environment the display device is used in. For example, a LCD display device may be designed based on maximum loading and an ambient temperature of around 40 °C for potentially anticipated user behaviors. Some configurable parameters of a display device can also be set to the worse use cases. For example, local dimming of a display device can be disabled and the brightness of the display device can be set to maximum, and full backlight can be activated on a full white screen with local dimming enabled for a LCD display. On the other hand, real world applications can be different from the worse use cases most of the time. A full load operation is uncommon for a display device, and a typical usage results in 70% to 80% of maximum load. A TV system can be typically used indoors, where the ambient temperature is around 25 °C to 30 °C instead of ambient 40 °C the TV is designed for. Therefore, a display device designed based on the maximum loading and worse use cases can have components selected to have performance meeting conditions worse than the average use cases. Accordingly, such components and the display device can be more expensive or otherwise consume more resources unnecessarily most of the time.

In some embodiments, a display device can be designed for average use cases, where a component can be selected to have performance meeting conditions for average use cases. Accordingly, a display device designed for average use cases can have many benefits such as saving power, reducing the heat generated, extending the life time of the devices, and other benefits. However, the display device may not function properly for use cases that demand higher performance than the average use cases the display device is designed for. Mechanisms are to be developed to protect the components and the display device to operate correctly when the conditions of the use case exceed the performance of the components and the display device.

In some embodiments, one or more sensors can be added to a display device to monitor the temperature of the display device, such as the temperature of one or more hotspots. Based on the feedback of the temperature, a controller of the display device can reduce the power consumption of the display device. In some embodiments, the controller can reduce the brightness of the display device to reduce the overall power consumption when the temperature exceeds a predetermined limit for the display device to prevent overheating. When the display device is a LCD display device, the controller can control the backlight to control the brightness of the display device to prevent overheating. Consequently, components of a display device, such as a PSU or components of the PSU can be selected to meet performance conditions for average use cases, which can result in reduced cost for the display device. At the meantime, the display device can support performance at a peak power consumption level higher than the components of the display device can support, hence providing peak power enhancement.

In some aspects, a display device can include a display panel, a light-emitting diode (LED) backlight, a display driver, a first board, and a second board. The display device can be configured to display information. The backlight can be a form of illumination used in a LCD display device that provides light from the back or side of a display panel of the display device. The LED backlight can be configured to control a brightness of the display panel. The display driver can be configured to control operations of the LED backlight. The first board can include a PSU and a sensor, where the PSU can be configured to provide power to the display panel, and the sensor can be configured to collect a temperature data indicating a temperature of a hotspot of the PSU or the first board. The second board can include a controller. The first board can be configured to send to the controller of the second board a signal based on the temperature data collected by the sensor. The controller can be configured to receive the signal based on the temperature data, and further send a command to the display driver to adjust the brightness level of the LED backlight in response to the signal indicating the temperature of the hotspot exceeds a predetermined threshold.

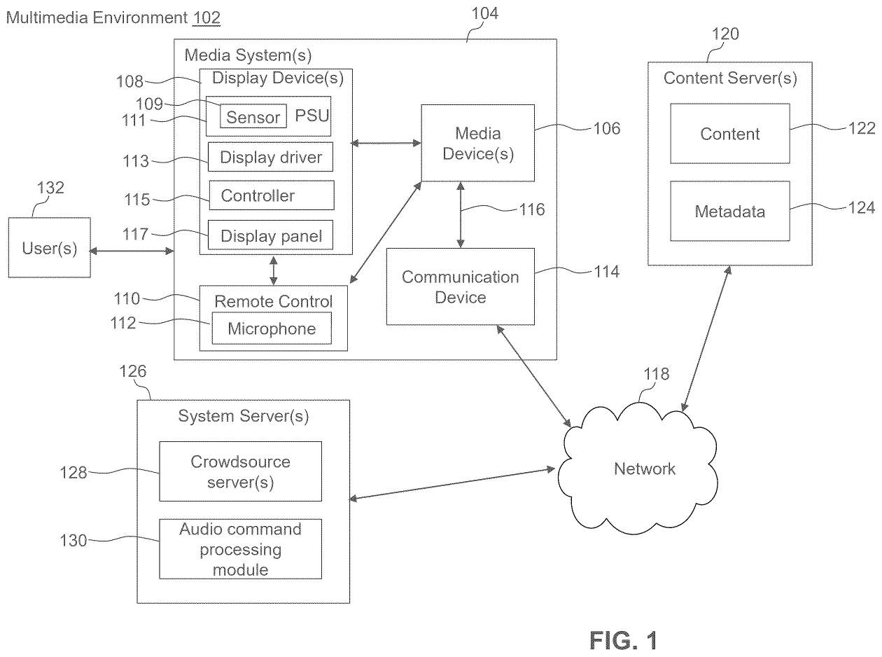

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some embodiments, media device 106 can be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as WiFi) and/or wired connections.

In various embodiments, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, laptop computer, smartphone, wearable, on-screen controls, integrated control buttons, audio controls, or any combination thereof, to name just a few examples. In an embodiment, the remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers, channels or sources 120). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form.

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126.

The media devices 106 may exist in thousands or millions of media systems 104. Accordingly, the media devices 106 may lend themselves to crowdsourcing embodiments and, thus, the system servers 126 may include one or more crowdsource servers 128.

For example, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users'viewing experience at particular portions of the movie (for example, when the soundtrack of the movie is difficult to hear), and turning closed captioning off may enhance users'viewing experience at other portions of the movie (for example, when displaying closed captioning obstructs critical visual aspects of the movie). Accordingly, the crowdsource server(s) 128 may operate to cause closed captioning to be automatically turned on and/or off during future streamings of the movie.

The system servers 126 may also include an audio command processing module 130. As noted above, the remote control 110 may include a microphone 112. The microphone 112 may receive audio data from users 132 (as well as other sources, such as the display device 108). In some embodiments, the media device 106 may be audio responsive, and the audio data may represent verbal commands from the user 132 to control the media device 106 as well as other components in the media system 104, such as the display device 108.

In some embodiments, the audio data received by the microphone 112 in the remote control 110 is transferred to the media device 106, which is then forwarded to the audio command processing module 130 in the system servers 126. The audio command processing module 130 may operate to process and analyze the received audio data to recognize the user 132's verbal command. The audio command processing module 130 may then forward the verbal command back to the media device 106 for processing.

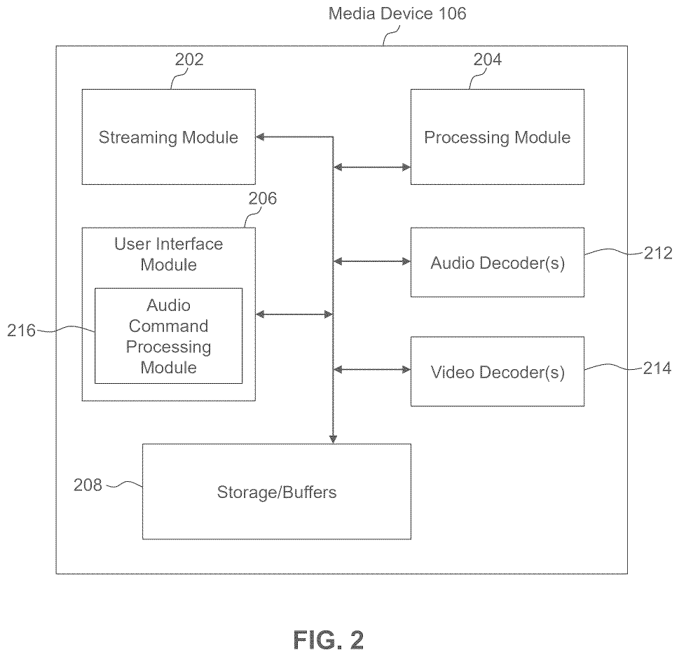

In some embodiments, the audio data may be alternatively or additionally processed and analyzed by an audio command processing module 216 in the media device 106 (see FIG. 2). The media device 106 and the system servers 126 may then cooperate to pick one of the verbal commands to process (either the verbal command recognized by the audio command processing module 130 in the system servers 126, or the verbal command recognized by the audio command processing module 216 in the media device 106).

FIG. 2 illustrates a block diagram of an example media device 106, according to some embodiments. Media device 106 may include a streaming module 202, processing module 204, storage/buffers 208, and user interface module 206. As described above, the user interface module 206 may include the audio command processing module 216.

The media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, AV1, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, AV1, AV1, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some embodiments, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming module 202 of the media device 106 may request the selected content from the content server(s) 120 over the network 118. The content server(s) 120 may transmit the requested content to the streaming module 202. The media device 106 may transmit the received content to the display device 108 for playback to the user 132.

In streaming embodiments, the streaming module 202 may transmit the content to the display device 108 in real time or near real time as it receives such content from the content server(s) 120. In non-streaming embodiments, the media device 106 may store the content received from content server(s) 120 in storage/buffers 208 for later playback on display device 108.

Display Device having Power Control Based on Temperature Data

Referring to FIG. 1, in some embodiments, display devices 108 can include a display panel 117, a display driver 113 coupled to display panel 117, a PSU 111, a sensor 109, and a controller 115 to control the power consumption of display panel 117. In some embodiments, sensor 109 can be located within PSU 111 to measure a temperature of a hotspot within PSU 111, while controller 115 can control the power consumption of the display panel 117 based on the measured temperature. In some embodiments, PSU 111 and sensor 109 can be located at a first board, while controller 115 can be located in a second board separated from the first board.

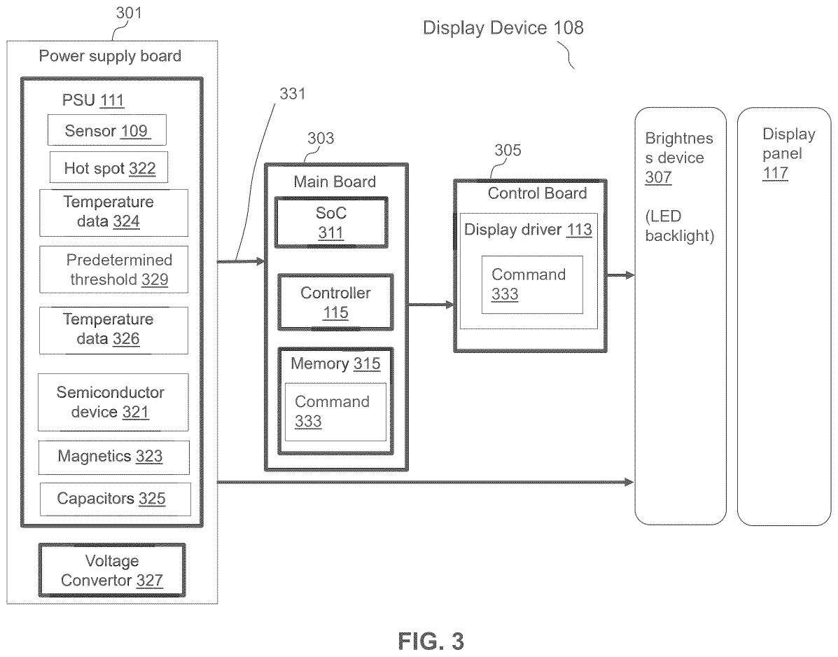

FIG. 3 illustrates a block diagram showing more details of display device 108, according to some embodiments.

In some embodiments, PSU 111 and sensor 109 can be located at a first board 301, which can be a power supply board. Controller 115 can be located at a second board 303, which can be a main board. In addition, display driver 113 can be located in a third board 305, which can be a control board. In some embodiments, first board 301, second board 303, and third board 305 can be 3 separated boards. In some embodiments, first board 301, second board 303, and third board 305 can each be a printed circuit board (PCB) separated from other boards. In some embodiments, there can be fewer than 3 boards, and devices can be placed in one board or two separated boards.

In some embodiments, sensor 109 can be a thermal sensor to collect temperature data 324. Sensor 109 can convert temperature information into usable electrical signals or data for use by other devices or systems. Sensor 109 can include a resistance temperature detector, a thermistor, a thermometer, an infrared (IR) sensor, an integrated circuit (IC) temperature sensor, or any other kinds of thermal sensor.

In some embodiments, display panel 117 can be coupled to a brightness device 307 to control the brightness of display panel 117. In some embodiments, display panel 117 can be a liquid-crystal-display (LCD) display panel, and brightness device 307 can be a light-emitting diode (LED) backlight for display panel 117. In some embodiments, display driver 113 can be configured to control operations of the LED backlight for display panel 117 that is a LCD display. In some embodiments, display driver 113 can be located in a LCD controller board and configured to control operations of the LED backlight for a LCD display panel, and display device 108 can be a LCD smart television (TV). In some embodiments, brightness device 307 can be an edge-lit LED (ELED) backlight where a plurality of LEDs form a line around a rim of display panel 117. In some embodiments, brightness device 307 can be a direct-lit LED (DLED) backlight where a plurality of LEDs are placed directly behind display panel 117 at equally spaced intervals.

In some embodiments, PSU 111 can include one or more semiconductor devices 321, one or more magnetics devices 323, and one or more capacitors 325. In some embodiments, semiconductor devices 321, one or more magnetics devices 323, and one or more capacitors 325 can form a transformer or other components of PSU 111. In some embodiments, components of PSU 111 can have some performance range beyond which the components would not function properly. For example, a capacitor designed for a maximum operating temperature of 25 °C to 30 °C may not function properly when PSU 111 or display device 108 is placed in a space with an ambient temperature of 40 °C.

In some embodiments, second board 303 can further include a digital signal processing device 311 and a memory device 315 configured to process the information being displayed on display panel 117.

In some embodiments, PSU 111 can be configured to provide power through a voltage converter 327 to display panel 117 and/or brightness device 307. Sensor 109 can be configured to collect temperature data 324 indicating a temperature of a hotspot 322. In some embodiments, sensor 109 can be placed within PSU 111 to collect temperature of a hotspot within PSU 111. In some embodiments, sensor 109 can be placed outside PSU 111 on first board 301. Even though only one sensor 109 is shown in FIG. 3, there can be multiple sensors placed in an area that can form a hot spot. In some embodiments, there can be a single sensor placed within PSU 111.

In some embodiments, a signal 331 can be generated based on temperature data 324, and signal 331 can be sent to controller 115. In some embodiments, controller 115 can receive signal 331, which is generated based on temperature data 324, and further send a command 333 to display driver 113 to reduce power consumption by display panel 117 in response to signal 331 indicating the temperature of hotspot 322 exceeds a predetermined threshold 329. In some embodiments, command 333 sent by controller 115 can be an instruction understandable by display driver 113 to instruct display driver 113 to reduce a brightness level of display panel 117 in order to reduce the power consumption of display panel 117. In some embodiments, command 333 sent by controller 115 can instruct display driver 113 to reduce a brightness level of the LED backlight for display panel 117, where the LED backlight can be an example of brightness device 307. In some embodiments, command 333 can reduce the brightness level of the LED backlight by way of pulse width modulation (PWM) or by adjusting a variable voltage to control the brightness level of the LED backlight, where the LED backlight can be an example of brightness device 307.

In some embodiments, by adjusting the brightness of display panel 117, power consumption of display panel 117 can be reduced. Hence, components of PSU 111 designed for a first range, e.g., a range smaller than operating temperature of 25 °C to 30 °C, may still function properly when signal 331 indicating the temperature of hotspot 322 exceeds a predetermined threshold 329, e.g., 30 °C. For example, when signal 331 indicating that the temperature of hotspot 322 is of 40 °C exceeding predetermined threshold 329 that is 30 °C, controller 115 can instruct to reduce the power consumption of display panel 117. With reduced power consumption, components of PSU 111 can still perform the intended functions.

In some embodiments, temperature data 324 can be a first temperature data, signal 331 can be a first signal, command 333 can be a first command. In addition, sensor 109 can be configured to collect a second temperature data 326 indicating a second temperature of hotspot 322 at a second time instance. In addition, controller 115 can receive a second signal based on second temperature data 326, and further send a second command to display driver 113 to adjust the power consumption by display panel 117 in response to the second signal indicating the second temperature of hotspot 322 is below predetermined threshold 329. In some embodiments, when second temperature of hotspot 322 is below predetermined threshold 329, PSU 111 can operate in a normal use case, and there is no need to reduce the power consumption by display panel 117.

In some embodiments, sensor 109 can be a first sensor, and display panel 117 can further include a second sensor to collect temperature data of display panel 117, and further send a signal based on the temperature data of display panel 117 to controller 115. Controller 115 can further determine a corresponding command to adjust the power consumption by display panel 117.

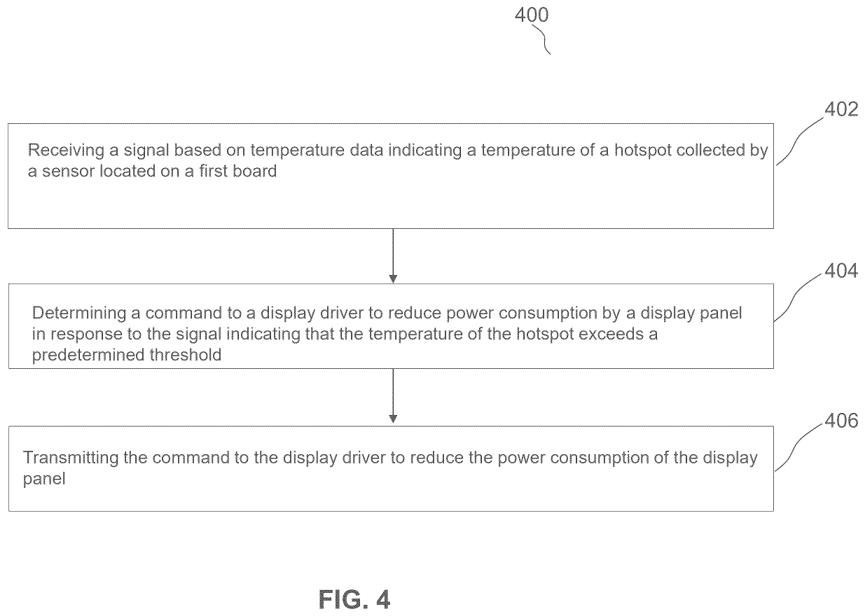

FIG. 4 illustrates a flow diagram of a method 400 for controller 115 of display device 108 to control power consumption of display panel 117 of display device 108, according to some embodiments. Method 400 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4, as will be understood by a person of ordinary skill in the art. Method 400 shall be described with reference to FIG. 3. However, method 400 is not limited to that example embodiment.

In step 402, controller 115 can receive signal 331 based on temperature data 324 indicating a temperature of hotspot 322 collected by sensor 109 located on first board 301. In some embodiments, first board 301 can include PSU 111 configured to provide power to display panel 117. Controller 115 is located in second board 303 separated from first board 301. In some embodiments, sensor 109 can be located within PSU 111. In some embodiments, sensor 109 can be located on first board 301 external to PSU 111.

In step 404, controller 115 can determine command 333 to display driver 113 to reduce power consumption by display panel 117 in response to signal 331 indicating that the temperature of hotspot 322 exceeds predetermined threshold 329. In some embodiments, command 333 can be an instruction to display driver 113 causing display driver 113 adjusting the brightness of brightness device 307 to reduce the power consumption. In some embodiments, signal 331 can indicate a comparison result that the temperature of hotspot 322 exceeds predetermined threshold 329. In some embodiments, signal 331 can include both temperature data 324 and predetermined threshold 329, while controller 115 can make a determination that temperature data 324 indicates a temperature of hotspot 322 being higher than predetermined threshold 329.

In step 406, controller 115 can transmit command 333 to display driver 113 to reduce the power consumption of display panel 117. In some embodiments, display panel 117 can be a LCD display panel, display driver 113 can be located in a LCD controller board and configured to control operations of a LED backlight, which is brightness device 307 for display panel 117.

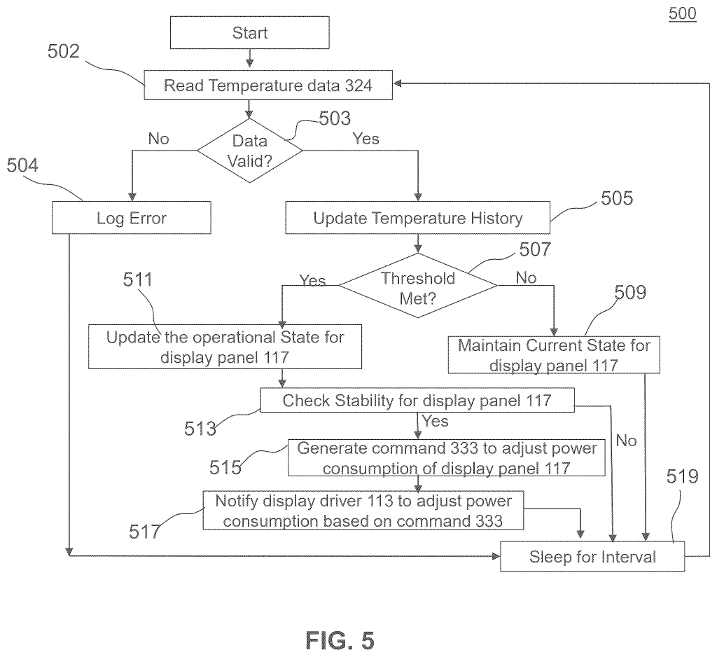

FIG. 5 illustrates a flow diagram of a method 500 for controller 115 of display device 108 to control power consumption of display panel 117 of display device 108, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art. Method 400 shall be described with reference to FIG. 3. However, method 500 is not limited to that example embodiment.

In step 502, controller 115 can read temperature data 324, which can be collected by sensor 109. In some embodiments, sensor 109 can be located on first board 301. In some embodiments, sensor 109 can be located within PSU 111. Temperature data 324 can indicate a temperature of hotspot 322 located within PSU 111 or on first board 301. In some embodiments, controller 115 can receive temperature data 324 carried by signal 331.

In step 503, controller 115 can check the validity of temperature data 324. Temperature data 324 should have a predetermined format, such as its precision and range. Temperature data 324 may be distorted in the communication process from sensor 109 to controller 105. Hence, controller 115 can check the validity of temperature data 324 to ensure temperature data 324 received by controller 115 is of a valid format.

In step 504, when controller 115 determines temperature data 324 is not of a valid format, controller 115 can log the error. Afterwards, controller 115 can move to step 519 to sleep for an interval of a predetermined amount of time before performing another reading of temperature data 324 collected by sensor 109.

In step 505, after controller 115 determines temperature data 324 is of a valid format, controller 115 can update the temperature history of temperature of hotspot 322, where the temperature history can include a list of saved temperature data 324 collected by sensor 109 at various time instances.

In step 507, controller 115 can determine whether temperature data 324 indicates a temperature of hotspot 322 exceeding predetermined threshold 329. Controller 115 can perform a comparison of numbers, where temperature data 324 is a number indicating the temperature of hotspot 322, and predetermined threshold 329 is also a number indicating a predetermined maximal temperature allocated for display panel to operate at a certain power consumption.

In step 509, when controller 115 determines temperature data 324 does not exceed predetermined threshold 329, controller 115 can determine to maintain the current state of operation for display panel 117. Afterwards, controller 115 can move to step 519 to sleep for an interval of a predetermined amount of time before performing another reading of temperature data 324 collected by sensor 109.

In step 511, when controller 115 determines temperature data 324 indicates the temperature at hotspot 322 exceeds predetermined threshold 329, controller 115 can determine to update the operational state of display panel 117 so that display panel 117 can operate with reduced power consumption.

In step 513, before reducing the power consumption of display panel 117, controller 115 can perform operations to check the stability for display panel 117. When controller 115 determines that display panel 117 may not be stable to operate in reduced power consumption, controller 115 may move to step 519 to sleep for an interval of a predetermined amount of time before performing another reading of temperature data 324 collected by sensor 109. In some embodiments, controller 115 may determine to generate an alert to indicate to a user that display panel 117 may operate in an unstable state.

In step 515, after controller 115 determines that display panel 117 can be stable to operate in reduced power consumption, controller 115 can generate command 333 to adjust power consumption for display panel 117.

In step 517, controller 115 can further notify display driver 113 to adjust power consumption for display panel 117 based on command 333. Controller 115 can send command 333 to display driver 113. In some embodiments, display driver 113 can adjust the brightness of display panel 117 to reduce the power consumption by display panel 117.

In step 519, controller 115 can sleep for an interval of a predetermined amount of time before going to step 502 performing another reading of temperature data 324 collected by sensor 109.

### Example Computer System

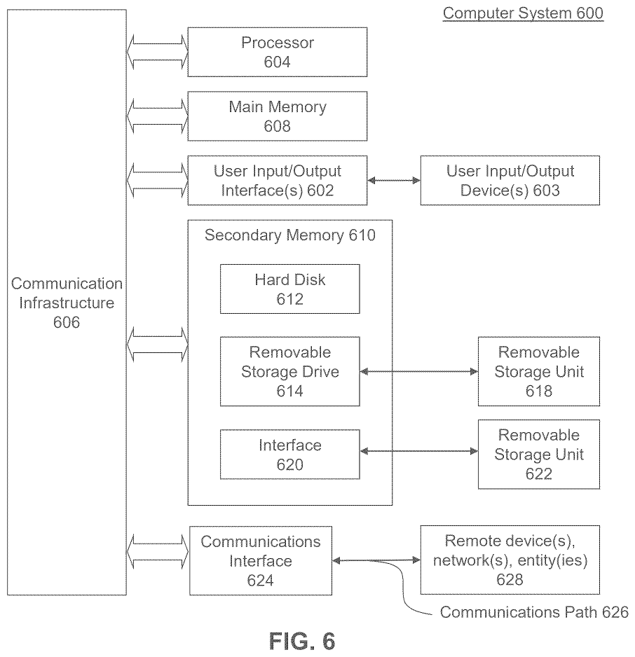

Various embodiments may be implemented, for example, using one or more well-known computer systems, such as computer system 600 shown in FIG. 6. For example, the media device 106 may be implemented using combinations or sub-combinations of computer system 600. Also or alternatively, one or more computer systems 600 may be used, for example, to implement any of the embodiments discussed herein, as well as combinations and sub-combinations thereof. In some embodiments, computer systems 600 can implement functions of controller 115, display device 108, media device 106, operations illustrated in method 400 and method 500, and any other operations discussed herein.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600 or processor(s) 604), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

### Conclusion

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A display device, comprising:
a display panel configured to display information;
a display driver coupled to the display panel;
a first board comprising a power supply unit (PSU) configured to provide power to the display panel and a sensor configured to collect temperature data indicating a temperature of a hotspot, wherein a signal based on the temperature data is sent to a controller; and
a second board comprising the controller configured to receive the signal based on the temperature data, and further transmit a command to the display driver to reduce power consumption by the display panel in response to the signal indicating the temperature of the hotspot exceeds a predetermined threshold.

2. The display device of claim 1, wherein the display driver is located in a third board separated from the first board and the second board.

3. The display device of claim 1, wherein the first board is a first printed circuit board (PCB) to support the PSU, and the second board is a second PCB to support the controller.

4. The display device of claim 1, wherein the PSU further comprises a semiconductor device, a magnetics device, and one or more capacitors.

5. The display device of claim 1, wherein the second board further comprises a digital signal processing device and a memory device configured to process the information being displayed on the display panel.

6. The display device of claim 1, wherein the display panel is a liquid-crystal-display (LCD) display panel, and the display driver is configured to control operations of a light-emitting diode (LED) backlight for the display panel.

7. The display device of claim 1, wherein the command transmitted by the controller is an instruction to reduce a brightness level of the display panel in order to reduce the power consumption of the display panel.

8. The display device of claim 7, wherein the display panel is a liquid-crystal-display (LCD) display panel, the display driver is located in a LCD controller board and configured to control operations of a light-emitting diode (LED) backlight for the display panel, and the display device is a LCD smart television (TV).

9. The display device of claim 8, wherein the LED backlight is an edge-lit LED (ELED) backlight where a plurality of LEDs form a line around a rim of the display panel, or a direct-lit LED (DLED) backlight where a plurality of LEDs are placed directly behind the display panel at equally spaced intervals.

10. The display device of claim 8, wherein the command transmitted by the controller is an instruction to reduce a brightness level of the LED backlight for the display panel.

11. The display device of claim 10, wherein the instruction is to reduce the brightness level of the LED backlight by way of pulse width modulation (PWM) or by adjusting a variable voltage to control the brightness level of the LED backlight.

12. The display device of claim 1, wherein the temperature data is first temperature data, the signal is a first signal, the command is a first command, and the sensor is configured to collect second temperature data indicating a second temperature of the hotspot, and the controller is configured to receive a second signal based on the second temperature data, and further transmit a second command to the display driver to adjust the power consumption by the display panel in response to the second signal indicating the second temperature of the hotspot is below the predetermined threshold.

13. The display device of claim 1, wherein the sensor is a first sensor, and the display panel further comprises a second sensor to collect temperature data of the display panel, and further transmit a second signal based on the temperature data of the display panel to the controller.

14. A method for controlling a display device, comprising:
receiving, by a controller, a signal based on temperature data indicating a temperature of a hotspot collected by a sensor located on a first board comprising a power supply unit (PSU), wherein the PSU is configured to provide power to a display panel of the display device, and a controller is located in a second board separated from the first board;
determining, by the controller, a command for a display driver to reduce power consumption by the display panel in response to the signal indicating that the temperature of the hotspot exceeds a predetermined threshold; and
transmit, by the controller, the command to the display driver to reduce the power consumption of the display panel.

15. The method of claim 14, wherein the display driver is located in a third board separated from the first board and the second board.

16. The method of claim 14, wherein the display panel is a liquid-crystal-display (LCD) display panel, and the display driver is configured to control operations of a light-emitting diode (LED) backlight for the display panel, and the command is an instruction to reduce a brightness level of the display panel in order to reduce the power consumption of the display panel.

17. The method of claim 14, wherein the display panel is a liquid-crystal-display (LCD) display panel, the display driver is located in a LCD controller board and configured to control operations of a light-emitting diode (LED) backlight for the display panel, and the display device is a LCD smart television (TV).

18. A display device, comprising:
a display panel configured to display information;
a light-emitting diode (LED) backlight configured to control a brightness of the display panel;
a display driver configured to control operations of the LED backlight;
a first board comprising a power supply unit (PSU) configured to provide power to the display panel and a sensor configured to collect temperature data indicating a temperature of a hotspot, wherein the first board is configured to send to a controller a signal based on the temperature data; and
a second board comprising the controller configured to receive the signal based on the temperature data, and further transmit a command to the display driver to adjust the brightness level of the LED backlight in response to the signal indicating the temperature of the hotspot exceeds a predetermined threshold.

19. The display device of claim 18, wherein the display panel is a liquid-crystal-display (LCD) display panel, the display driver is located in a LCD controller board and configured to control operations of the LED backlight for the display panel, and the display device is a LCD smart television (TV).

20. The display device of claim 18, wherein the LED backlight is an edge-lit LED (ELED) backlight where a plurality of LEDs form a line around a rim of the display panel, or a direct-lit LED (DLED) backlight where a plurality of LEDs are placed directly behind the display panel at equally spaced intervals.
